(19) United States
(12) Patent Application Publication
(10) Pub. No.: US 2013/0168196 A1
(43) Pub. Date: Jul. 4, 2013

(54) VACUUM-SHRINKABLE LUGGAGE CAPABLE OF COMPACTING ITEMS ENCLOSED THEREIN AND METHOD OF ASSEMBLING THE LUGGAGE

(71) Applicant: Andrew Alexander Stanley, Lynn, MA (US)

(72) Inventor: Andrew Alexander Stanley, Lynn, MA (US)

(21) Appl. No.: 13/341,996

(22) Filed: Dec. 31, 2011

(51) Int. Cl. A45C 13/00; B23P 11/00; A45C 15/00; A45C 5/00

(52) U.S. Cl. 190/100; 29/428

(57) ABSTRACT

Vacuum-shrinkable luggage is disclosed for compactly enclosing and transporting at least one item enclosed therein, and a method of assembling same. The luggage compresses the at least one item enclosed therein such that the size of the luggage decreases. The luggage defines a compartment therein for containing the item. Collapsible panels forming walls of the luggage are made from a material that prevents air seepage through the panels. Seals are provided to prevent air seepage around edges of the panels. A vacuum source in air communication with the compartment establishes low air pressure within the compartment. The vacuum source causes the walls of the luggage to shrink and/or move inwardly so as to compress or compact the item, also reducing the size of the luggage.

### FIELD OF THE INVENTION

This invention relates generally to luggage, and more particularly to luggage optimized for travel size restrictions.

### BACKGROUND OF THE INVENTION

Travelers on airplanes, trains, inter-city buses, and other public transportation conveyances often want to carry their luggage with them on the conveyance. The luggage usually contains personal items, such as clothing, reading material, electronic devices, personal care items, medications, and other items. However, storage space allocated to each traveler on these public transportation conveyances is typically limited or severely restricted by the public transportation carrier.

For example, in the case of airline travel, airline carriers charge a fee for each checked piece of luggage exceeding a set size limit. To determine whether a piece of luggage exceeds the size limit, one measures and adds the width, height, and depth of the individual luggage piece, and ten compares the sum to a set total dimension in measured in inches. Carry-on luggage must meet set size limitations, so that the luggage can be stowed under the traveler's seat or in an overhead compartment. In the case of one airline, the size limitation for carry-on luggage is 55 inches, as determined by adding the length, width, and height measurements of the luggage piece. Many airline carriers also charge an additional fee for each piece of luggage checked-in by the traveler.

Luggage restrictions also apply to train travel. For example, Amtrak®, which is a corporation delivering rail passenger service in the United States, requires that checked-in luggage not exceed 108 inches total, and carry-on luggage not exceed 64 inches total. In addition, Amtrak® allows each ticketed passenger to check-in three luggage pieces, not to exceed 50 pounds per piece, at no charge. However, up to three additional luggage pieces will be accepted by Amtrak® upon payment of a surcharge. The registered mark “Amtrak®” is owned by the National Railroad Passenger Corporation located in Washington, D.C., U.S.A.

Luggage restrictions apply to inter-city bus travel, as well. For example, in the case of Greyhound^{SM}, which is an inter-city bus carrier, the traveler pays a fee if his luggage exceeds a set size limit. Also, in the case of Greyhound^{SM}, one piece of luggage is checked free of charge for adults and children. However, one additional luggage piece will be checked for an additional charge, and luggage beyond two pieces face yet another charge. “Greyhound^{SM}” is a service mark owned by Greyhound Lines, Incorporated located in Dallas, Tex., U.S.A. Moreover, in the case of many inter-city bus carriers, carry-on luggage must be sized to fit in overhead compartments or under the traveler's seat.

Therefore, it is desirable for travelers on public transportation conveyances to reduce the size and/or number of luggage pieces to avoid additional luggage fees. It is also therefore desirable for travelers on public transportation conveyances to maximize the number of articles packed in each individual luggage piece to reduce the number of luggage pieces, while keeping the size of the luggage below a threshold size. Reducing the number of luggage pieces reduces the excess luggage fees otherwise payable to the public transportation carrier.

In addition, individuals not traveling on public conveyances often have a need to fit luggage into a limited space. For example, families traveling on holiday or vacation by private automobile often have severely limited space in the automobile to stow the family's travel items. Such items may include the previously mentioned clothing, reading material, electronic devices, personal care items, medications, and may also include other items, such as souvenirs and large beach towels.

Further, even individuals not traveling in a private automobile or other private conveyance may have a need to reduce luggage space. As an example, an individual who has finished exercising at a local gymnasium or health club may have a need to compactly stow a duffle bag, which may contain exercise apparel and bath towels, within the limited space of a typical upright and narrow gymnasium or health club storage locker.

Thus, many individuals in a variety of situations are faced with the need to minimize both the size and number of luggage items, so as to avoid extra baggage fees charged by public transportation carriers, and/or so as to increase the chance that the luggage will fit within limited space available for stowing the luggage.

Various configurations of luggage that can increase storage efficiency are known. For example, a suitcase with specially arranged sealable compartments for vacuum sealing of articles of travel such as clothing and makeup accessories allows air pressure in the compartments to be substantially reduced, separately or collectively, by means of a vacuum pump. Removal of air from the compartments reduces the volume of the articles contained therein to a minimum, and consequently allows more articles to fit within the suitcase, thereby increasing storage efficiency. However, the actual size of the suitcase remains unchanged, even after the articles inside are vacuum sealed.

In another known example, a suitcase is provided with a compressive liner encapsulating an air tight packing chamber and has a sealable opening to allow placement and removal of clothing and other articles within the packing chamber. In a relaxed state, the volume of the packing chamber is substantially greater than the volume of the suitcase interior, thereby enlarging the available packing space. When the liner is filled and sealed closed, air is withdrawn from the packing chamber by a motorized vacuum pump, causing the liner to collapse and compress the contents, thereby reducing the volume of the packing chamber to a size which fits within the closed suitcase. A one-way valve holds the vacuum within the chamber, thereby maintaining the liner in the collapsed state until the opening is unsealed. However, the actual size of the suitcase is unchanged after the articles inside are vacuum sealed.

### SUMMARY OF THE INVENTION

The invention is luggage that shrinks when vacuum pressure is applied within the luggage, thereby sucking out a substantial amount of air. The negative air pressure of the applied vacuum causes the sides of the luggage to move inward, crushing the clothing or other compactable items contained within the luggage, making the items take up less space, and also reducing the actual size of the luggage. This makes the luggage easier to carry, and easier to stow because the luggage is more likely to fit through and into small places.

A vacuum pump can be built in to the luggage. The vacuum pump can have its own rechargeable battery. Or the vacuum pump can plug into the wall. Alternatively, the vacuum pump can be separate from the luggage, and the luggage can just incorporate a vacuum port that enables a vacuum hose of a vacuum pump to be connected to the luggage.

The sides of the luggage can include two rigid panels cooperative with compressible walls, the rigid panels moving towards each other under vacuum pressure, or can be flexible, like the sides of a duffle bag that can collapse from all sides as the internal vacuum pressure pulls them inward.

The present invention provides a vacuum-shrinkable luggage piece capable of being reduced in size in response to applied vacuum pressure, even with at least one compressible item enclosed therein. The size reduction of the luggage due to the applied vacuum pressure reduces the total dimensions of the luggage, increasing the likelihood that the luggage will meet size restrictions. The present invention also provides a method of assembling such a vacuum-shrinkable luggage item.

Reducing the total dimension of the luggage can result in reduction or elimination of baggage surcharges by public transportation carriers, can allow more luggage pieces to be stowed in private transportation conveyances, such as family automobiles, and can allow luggage pieces, such as duffle bags, to be stowed in extremely confined spaces, such as gymnasium and health club storage lockers.

Luggage items include: a suitcase, a briefcase, a laptop case, a hat box, a purse, a duffle bag, or a back-pack, for example.

Collapsible panels (or walls) of the luggage can be made of a material that prevents air seepage through the panels. Alternatively, the panels can be coated with a layer of material, such as a layer of plastic material, impervious to air seepage therethrough. In addition, any seams in the luggage, such as seams between adjacently connected panels, can be sealed against air seepage by a sealing material. The sealing material can be a gasket made from an elastomer, such as rubber. Alternatively, the seams may be connected and sealed by a flexible adhesive. In either case, the seams remain sealed against air penetration even while the seams are being flexed during size reduction of the luggage.

The luggage is adapted to be opened, by means of a sealable opening, so that the compartment defined thereby is available to receive the items to be contained therein. After the items are placed within the compartment by the user of the luggage, the user may then close the luggage by closing the sealable opening. In this manner, the luggage becomes air-tight, except for a conduit that penetrates the luggage and that is in air communication with the compartment. The term “conduit” is intended herein to include any suitable connection, such as a port, a tubular structure, and/or an orifice structure. The inner end of the conduit is in air communication with the interior of the luggage, and the outer end of the conduit is open to the environment outside the luggage, so that the conduit can be connected to a vacuum source for evacuating air from the interior of the luggage.

A volume of air can be found within the interior of the luggage after the luggage is closed. A portion of the air is removed by a vacuum pump that is coupled to the outer end of the conduit. The vacuum pump can be electrically powered or can be hand powered.

The vacuum pump can be located outside the luggage, or can be built into the luggage. If the vacuum pump is built into the luggage, a suitable electrical connection of the built-in vacuum pump is accessible on an external surface of the luggage. A power supply, such as an electrical wall outlet, can supply electrical power to the electrical connection for operating the built-in vacuum pump.

Alternatively, a rechargeable battery can also be built into the luggage for providing electrical power to the built-in vacuum pump. In this case, the electrical connection is connected to the rechargeable battery, rather than connected to the internal vacuum pump, for recharging the rechargeable battery.

If the vacuum pump is located outside of the luggage, the external vacuum pump is connected directly to the power supply (e.g., an electrical wall outlet) for supplying electricity to the external vacuum pump.

As the vacuum pump operates, air is evacuated from the interior of the luggage. Evacuation of air from the luggage reduces air pressure within the luggage that forces the sides of the luggage to move until the panels compress the contents of the luggage.

Once the vacuum pump has substantially completed removing air from the interior of the luggage, the vacuum pump stops operating. If the pump is external to the luggage, the hose of the vacuum pump is removed from the conduit of the luggage. If the pump is internal to the luggage, a pressure relay senses that the movement of air has substantially stopped, and the vacuum pump is then turned off.

One general aspect of the invention is a vacuum-shrinkable luggage for compressing and carrying at least one item contained therein, the vacuum-shrinkable luggage including: a compressible air-tight luggage body defining a compartment for containing the at least one item, the compressible luggage body enabling the vacuum-shrinkable luggage to shrink in size as air pressure falls within the compressible luggage body; a conduit, in air communication with the compartment, for enabling air to leave the compartment so as to cause air pressure to fall within the compartment; and a valve, cooperative with the conduit, to ensure that air leaves, and cannot re-enter, the compartment so as to maintain a low air pressure condition within the compartment while the vacuum-shrinkable luggage is transported.

In some embodiments, the vacuum-shrinkable luggage further includes a vacuum source coupled to the conduit for causing air to leave the compartment.

In some embodiments, the vacuum source is disposed outside the compartment. In other embodiments, the vacuum source is disposed inside the compartment.

In some embodiments, the vacuum-shrinkable luggage further includes a power supply disposed in the compartment and coupled to the vacuum source for supplying power to the vacuum source.

In some embodiments, the vacuum-shrinkable luggage further includes a seal for sealing the compartment in a substantially air-tight manner.

Another general aspect of the invention is a vacuum-shrinkable luggage for compressing and carrying at least one item contained therein, the vacuum-shrinkable luggage including: a compressible air-tight luggage body having a sealable air-tight compartment for containing the at least one item therein, the compressible luggage body enabling the vacuum-shrinkable luggage to shrink in size as air pressure falls within the compressible luggage body; a conduit, in air-flow communication with the compartment, for enabling air to leave the compartment so as to cause air pressure to fall within the compartment; a valve, cooperative with the conduit, capable of ensuring that air can exit, and cannot re-enter, the compartment so as to create and then maintain a low air pressure condition within the compartment while the vacuum-shrinkable luggage is transported; and an electrically operable vacuum pump in airflow communication with the air pathway for evacuating air out of the compartment via the air pathway.

In some embodiments, the vacuum pump is disposed outside the compartment. In other embodiments, the vacuum pump is disposed inside the compartment.

In some embodiments, the vacuum-shrinkable luggage further includes an electrical power supply disposed within the compartment and coupled to the vacuum pump for supplying electrical power to the vacuum pump.

In some embodiments, the electrical power supply is a battery.

In some embodiments, the vacuum-shrinkable luggage further includes a seal in sealing relationship with the compartment for providing the compartment with an air-tight seal.

In some embodiments, the seal includes a plurality of seal elements adapted to surround the compartment.

Another general aspect of the invention is a method for assembling a vacuum-shrinkable luggage for compressing and carrying at least one item contained therein, the method including: providing a compressible air-tight luggage body defining a compartment for containing the at least one item, the compressible luggage body enabling the vacuum-shrinkable luggage to shrink in size as air pressure falls within the compressible luggage body; providing a conduit, in air communication with the compartment, for enabling air to leave the compartment so as to cause air pressure to fall within the compartment; and connecting a valve to the conduit, to ensure that air leaves, and cannot re-enter, the compartment so as to maintain a low air pressure condition within the compartment while the vacuum-shrinkable luggage is transported.

In some embodiments, the method further includes providing a vacuum source adapted to be coupled to the conduit for evacuating air through the conduit.

In some embodiments, providing a vacuum source includes providing a vacuum source adapted to be disposed outside the compartment. In other embodiments, providing a vacuum source includes providing a vacuum source adapted to be disposed inside the compartment.

In some embodiments, the method further includes configuring the compartment to receive a power supply adapted to be coupled to the vacuum source for supplying power to the vacuum source.

In some embodiments, the method further includes disposing a seal in sealing relationship with the compartment for providing the compartment with an air-tight seal.

### BRIEF DESCRIPTION OF THE DRAWINGS

The invention will be more fully understood by reference to the detailed description in conjunction with the following figures, wherein:

FIG. 1 is a view in perspective of a first embodiment luggage, such as a duffle bag, in an uncompressed state, this view showing a conduit sealably penetrating an air-impervious side panel belonging to the first embodiment luggage, the conduit being in the form of an orifice structure having an opening flush with the side panel;

FIG. 2 is a view in perspective of the first embodiment luggage in an uncompressed state, this view showing the conduit sealably penetrating the air-impervious side panel belonging to the first embodiment luggage, the conduit being in the form of the tubular structure having an end portion thereof outwardly projecting from the side panel, this view also showing a plurality of articles disposed in the luggage;

FIG. 3 is a fragmentary view in partial vertical section of the first embodiment luggage, this view showing the conduit in the form of the orifice structure sealably penetrating the air-impervious side panel belonging to the first embodiment luggage and also showing a one-way valve disposed in the orifice structure;

FIG. 4 is a fragmentary view in partial vertical section of the first embodiment luggage, this view showing the conduit in the form of the tubular structure sealably penetrating the air-impervious side panel belonging to the first embodiment luggage and also showing the one-way valve disposed in the tubular structure;

FIG. 5 is a fragmentary view in partial vertical section of the first embodiment luggage, this view showing the conduit in the form of the tubular structure sealably penetrating the side panel belonging to the first embodiment luggage and also showing the one-way valve disposed in the tubular structure, this view further showing an air-impervious layer adhered to all interior surfaces of the panels forming the first embodiment luggage;

FIG. 6 is a view in perspective of the first embodiment luggage in the uncompressed state and coupled to an external vacuum source, such as a conventional vacuum cleaner;

FIG. 7 is a view in perspective of the first embodiment luggage in the uncompressed state and coupled to the external vacuum source, such as a vacuum pump;

FIG. 8 is a view in perspective of the first embodiment luggage in a compressed state and coupled to the external vacuum source, such as the vacuum pump, this view also showing the plurality of items compressed or compacted in the luggage;

FIG. 9 is a view in perspective of a second embodiment luggage in an uncompressed state, this view showing an electrical connection in a side panel of the luggage for supplying electrical power to an internal vacuum source belonging to the second embodiment luggage;

FIG. 10 is a view in perspective of the second embodiment luggage in the uncompressed state and also showing an electrical adapter connected to the electrical connection;

FIG. 11 is a fragmentary view in partial vertical section of the second embodiment luggage, this view showing the internal vacuum source coupled to the conduit;

FIG. 12 is a fragmentary view in partial vertical section of a third embodiment luggage, this view showing the electrical connection as part of a rechargeable battery disposed in the third embodiment luggage for charging the rechargeable battery, the rechargeable battery being electrically coupled to the internal vacuum source belonging to the third embodiment luggage for supplying electrical power to the internal vacuum source;

FIG. 13 is a view in perspective of a fourth embodiment luggage, such as a suitcase, in an uncompressed state and coupled to an external vacuum source, such as the conventional vacuum cleaner, this view also showing the plurality of items disposed in the fourth embodiment luggage;

FIG. 14 is a view in perspective of the fourth embodiment luggage, such as the suitcase, in an uncompressed state and coupled to the external vacuum source, such as the external vacuum pump;

FIG. 15 is a side view in partial elevation of the fourth embodiment luggage;

FIG. 16 is a view taken along section line 16-16 of FIG. 15;

FIG. 17 is a view taken along section line 17-17 of FIG. 16;

FIG. 18 is a view taken along section line 18-18 of FIG. 15;

FIG. 19 is a view taken along section line 19-19 of FIG. 15;

FIG. 20 is a view in partial elevation of a fifth embodiment luggage in an uncompressed state, this view showing the electrical adapter connected to an electrical connection disposed in a side panel of the fifth embodiment luggage for supplying electrical power to an internal vacuum source belonging to the fifth embodiment luggage;

FIG. 21 is a view in partial vertical section of the fifth embodiment luggage in an uncompressed state, this view showing the internal vacuum source coupled to the conduit;

FIG. 22 is a view in partial vertical section of a sixth embodiment luggage, this view showing the electrical connection as part of a rechargeable battery disposed in the sixth embodiment luggage for charging the rechargeable battery, the rechargeable battery being coupled to the internal vacuum source belonging to the sixth embodiment luggage for supplying electrical power to the internal vacuum source;

FIG. 23 is a view in perspective of the previously mentioned fourth embodiment luggage with a closed cover, the fourth embodiment luggage being illustrated in an uncompressed state;

FIG. 24 is a view in perspective of the fourth embodiment luggage with the closed cover, the fourth embodiment luggage being illustrated in a compressed state reducing height, width and depth of the fourth embodiment luggage; and

FIG. 25 is a flowchart of an illustrative method of assembling a vacuum shrinkable luggage for compactly enclosing an item contained therein.

### DETAILED DESCRIPTION OF PREFERRED EMBODIMENTS

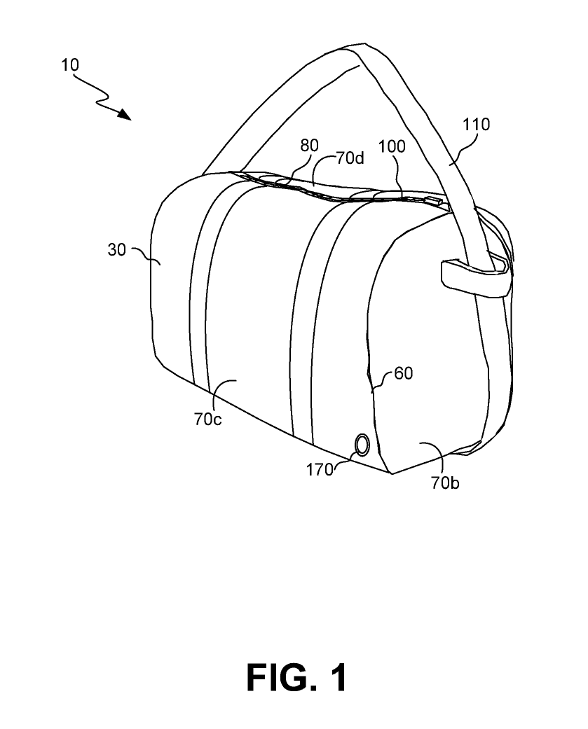

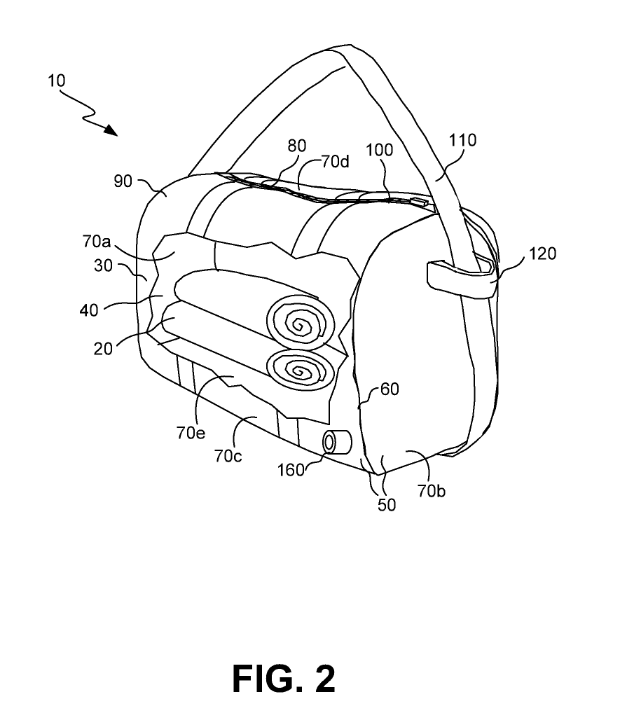

With reference to FIGS. 1 and 2, there is shown a first embodiment vacuum-shrinkable luggage, generally referred to as 10, for compactly enclosing an item 20 contained therein. There can be a plurality of items 20 to be compactly enclosed in luggage 10 and can include various types of items 20. For example, items 20 can be clothing, reading material, electronic devices, personal care items, souvenirs, beach towels, bath towels, exercise apparel, and/or other items 20. Luggage 10 includes a collapsible case body 30 defining a sealable air-tight compartment 40 therein for receiving items 20. Although not critical, it is nonetheless important that case body 30 be air-tight for reasons disclosed in detail hereinbelow. Case body 30 includes a plurality of adjacent and orthogonal panels 50. Adjacent panels 50 are joined together by an air-impervious seam 60 therebetween. More specifically, panels 50 include a flexible first panel 70a, a flexible second panel 70b, a flexible third panel 70c a flexible fourth panel 70d and a fifth panel 70e. Fifth panel 70e is oriented perpendicularly and orthogonally with respect to first panel 70a, second panel 70b, third panel 70c and fourth panel 70d. In addition, fifth panel 70e serves as a support base for items 20 and may be substantially rigid, if desired, for supporting items 20 thereon without downward sagging of fifth panel 70e. In this regard, there may be a substantially inflexible sheet, such as a sheet of cardboard or plastic (not shown) of suitable thickness, resting on fifth panel 70e for providing sufficient rigidity to fifth panel 70e. Second panel 70b is oriented substantially parallel to first panel 70a and fourth panel 70d is oriented substantially parallel to third panel 70c.

Referring again to FIGS. 1 and 2, panels 50 may be in the form of a continuous, single piece of material having a generally “clover leaf” outline with “leaves” that can be folded and joined at seams 60. Alternatively, panels 50 may be in the form of a plurality of separate pieces of material separately joined together at seams 60. A sealable opening 80 in provided in an upper portion 90 of case body 30 for providing access to compartment 40. Opening 80, which is interposed between third panel 70c and fourth panel 70d, can be opened and closed by means of an air-tight slide fastener, such as an air-tight zipper 100. It is important that zipper 100 be air-tight when used to close opening 80 for reasons disclosed in detail hereinbelow. Such an air-tight zipper 100 may be of a type that may be available from Wuxi Xibang Industrial and Trade Company, Limited located in Wuxi, China. A suitable carrying strap, harness, shoulder strap, or yoke 110 is attached to case body 30, such as by being sewn thereto or by being adhered thereto using a suitable adhesive. Carrying strap 110 allows a user of luggage 10 to conveniently carry luggage 10. A pair of carrying strap holders 120 (only one of which is shown) are connected to respective ones of first panel 70a and second panel 70b for holding carrying strap 110 to case body 30 in a manner that restricts excessive movement of carrying strap 110 while luggage 10 is being carried by the user. In this manner, presence of carrying strap 110 substantially prevents excessive yaw, pitch and roll of case body 30 while luggage 10 is being carried by the user.

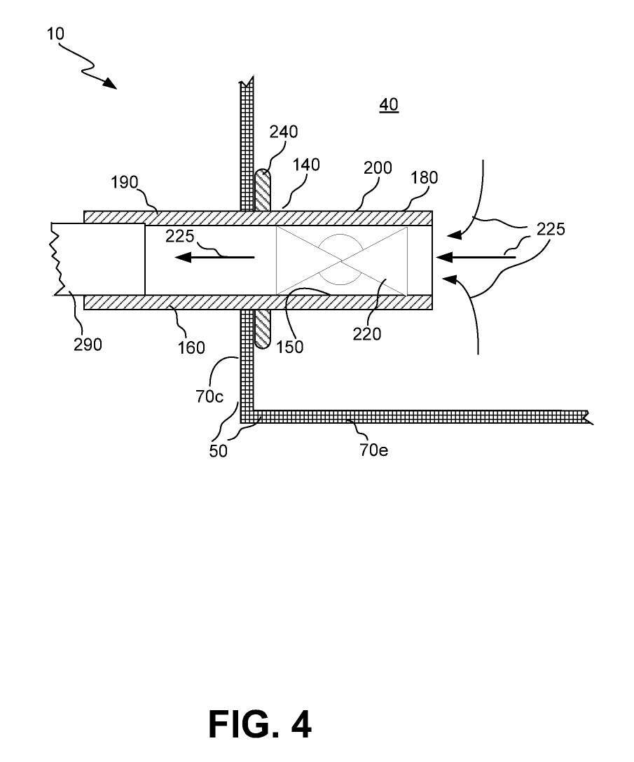

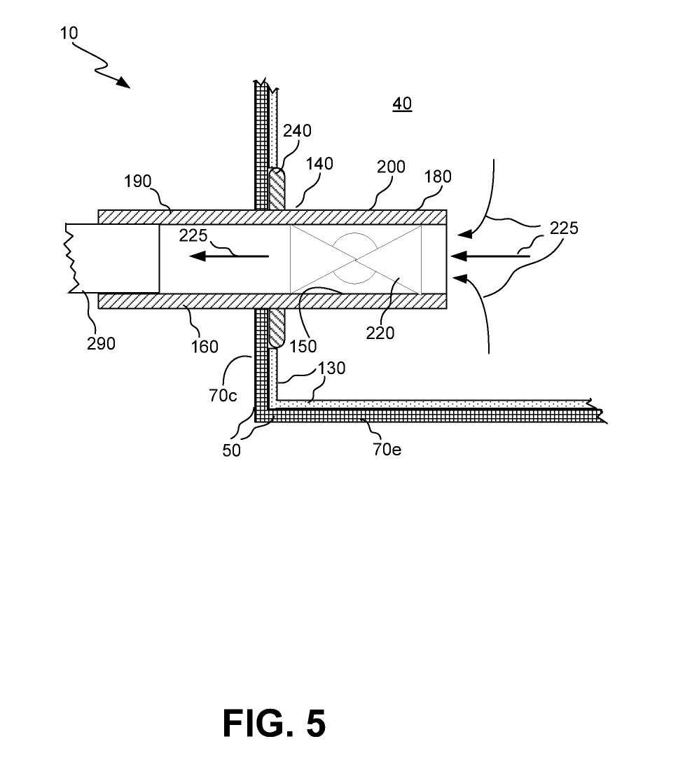

Referring to FIGS. 1, 2, 3, 4 and 5, and as previously mentioned, panels 70a/70b/70c/70d/70e are air-tight (i.e., impervious to air flow therethrough). In addition to being air-tight, panels 70a/70b/70c/70d are also flexible. To achieve flexibility and air tightness, panels 70a/70b/70c/70d/70e may be made from a flexible, air-tight fabric material of zero porosity, such as polyurethane-coated nylon. Alternatively, panels 70a/70b/70c/70d/70e may be made from a flexible organic material, such as cotton or wool, that is coated or layered on an interior or exterior surface thereof with a polymer impervious to air, such as a polyethylene sheet 130. Also, to provide added assurance that compartment 40 is air-tight, flexible seams 60 are also coated or layered with polyethylene sheet 130 or any suitable sealing substance.

Referring again to FIGS. 1, 2, 3, 4 and 5, sealably penetrating any one of panels 50, such as third panel 70c, is a conduit 140 defining a bore or air pathway 150 therethrough in communication with compartment 40. As described in detail hereinbelow, conduit 140 facilitates formation of relatively low air pressure within compartment 40. The term “conduit” is intended herein to include any suitable connection, such as a tubular structure 160 or, alternatively, an orifice structure 170. A first end portion 180 of tubular structure 160 is in communication with compartment 40 and a second end portion 190 extends outwardly from third panel 70c and is open to the atmosphere external to luggage 10. With respect to orifice structure 170, a first end portion 200 of orifice structure 170 is in communication with compartment 40 and a second end portion 210 of orifice structure 170 is flush with an outer surface of third panel 70c and is open to the atmosphere external to luggage 10. Having second end portion 210 flush with the outer surface of third panel 70c provides a more astatically pleasing or streamlined appearance to luggage 10 and tends to prevent interference of conduit 140 with nearby structures, such as adjacent luggage (not shown) and luggage racks (also not shown), or with individuals standing nearby. However, for purposes of brevity and clarity, the invention disclosed hereinafter will be described as having tubular structure 160, rather than orifice structure 170. Therefore, it should be appreciated that tubular structure 160 and orifice structure 170 are both suitable for use in the invention, depending on the preference of the user.

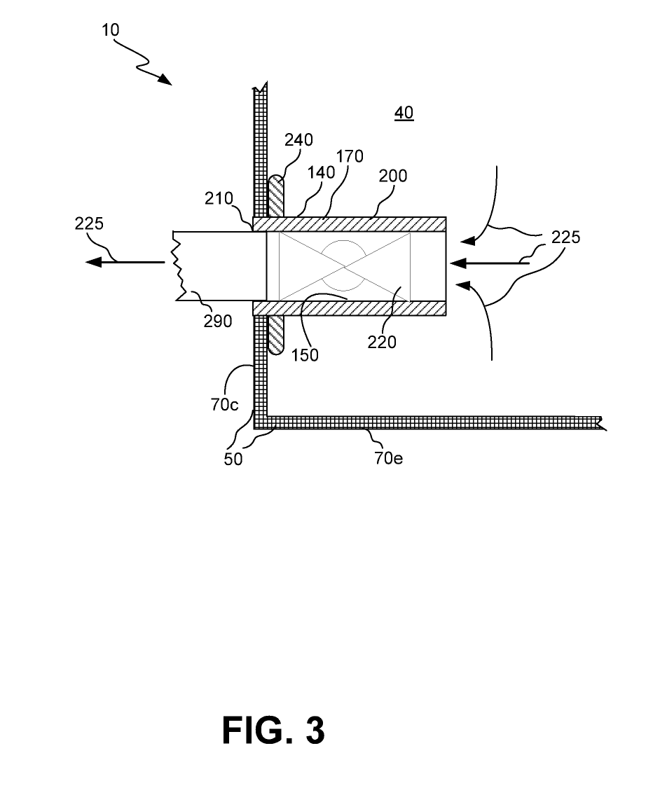

As seen in FIGS. 3, 4 and 5, a one-way valve 220, such as a check valve, is disposed in the air pathway 150 for permitting unidirectional air flow through air pathway 150. In this regard, valve 220 allows unidirectional air flow only out of compartment 40 in a direction as shown by a plurality of flow arrows 225. Valve 220 permits air flow only out of compartment 40, so that compartment 40 remains air-tight for maintaining low pressure within compartment 40, as described more fully hereinbelow. An annular sealing gasket 240, which may be made from an elastomer, is attached to an inner surface of third panel 70c and sealably surrounds second end portion 190 of tubular structure 160. A purpose of sealing gasket 240 is to provide a sealing function at the junction of second end portion 190 and third panel 70c, to provide additional assurance that compartment 40 is air-tight.

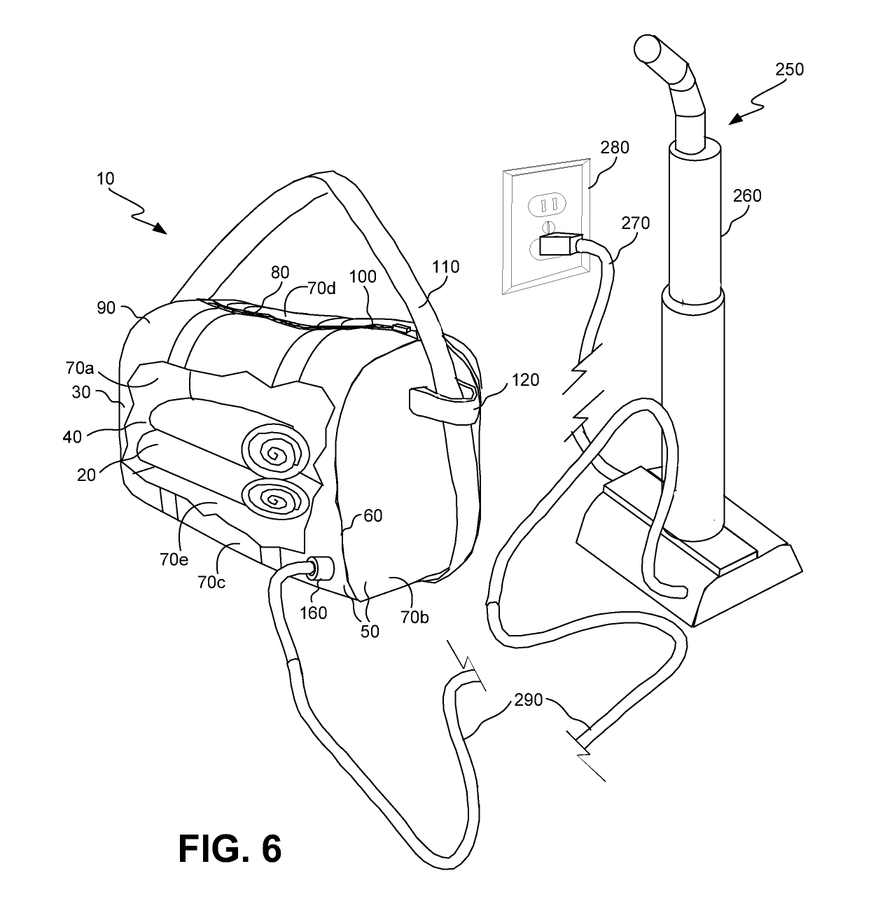

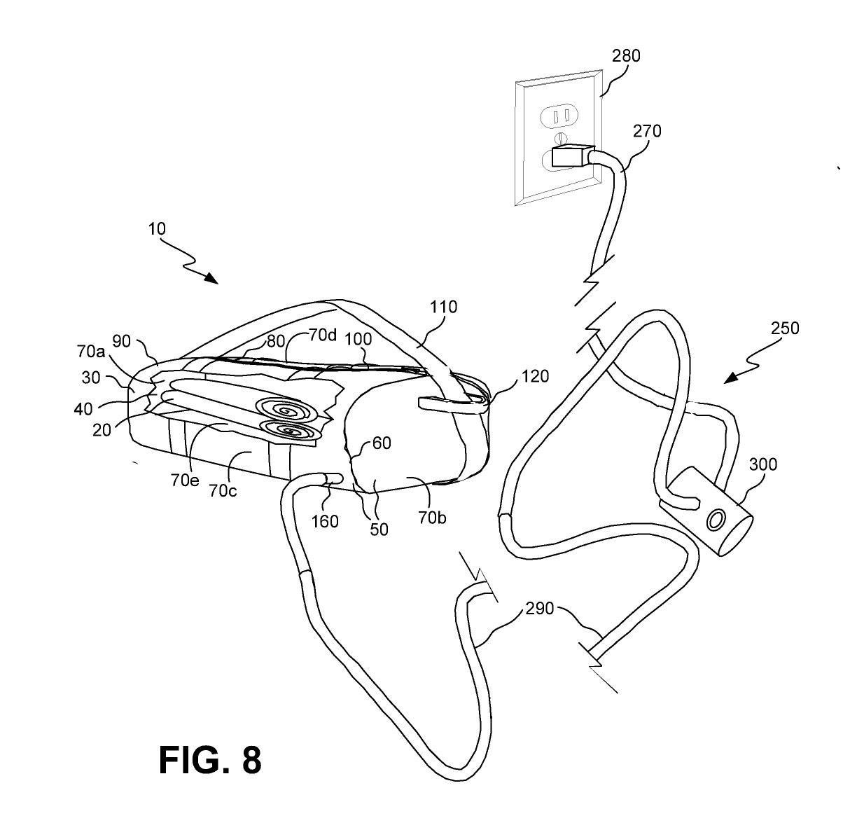

Referring to FIGS. 6, 7 and 8, air is typically present or trapped in compartment 40 after sealable opening 80 in luggage 10 is closed by means of air-tight zipper 100. It is desirable to remove or evacuate this air from compartment 40 in order to shrink the size (e.g., height, width, and depth) of luggage body 30 that belongs to luggage 10. As described in detail presently, this air is removed by an electrically operable vacuum source, generally referred to as 250, that is coupled to second end portion 190 of tubular structure 160. As described in detail momentarily, vacuum source 250 may be disposed externally to luggage body 30 (i.e., outside compartment 40) so as to provide an external vacuum source or within luggage body 30 (i.e., within compartment 40) so as to provide an internal vacuum source.

As best seen in FIG. 6, when vacuum source 250 is disposed externally to luggage body 30, so as to provide an external vacuum source, vacuum source 250 may be a conventional vacuum cleaner 260 having an electrical cord 270 connectable to an external power supply 280. External power supply 280 may be a conventional electrical wall outlet, as shown, for supplying electrical power to vacuum cleaner 260 to operate vacuum cleaner 260. A vacuum hose 290 interconnects vacuum cleaner 260 and second end portion 190 of tubular structure 160. When vacuum hose 290 is connected to second end portion 190 of tubular structure 160, vacuum hose 290 is in communication with air pathway 150. In this manner, operation of vacuum cleaner 260 will vacuum air from compartment 40, through air pathway 150, into vacuum hose 290 and to vacuum cleaner 260.

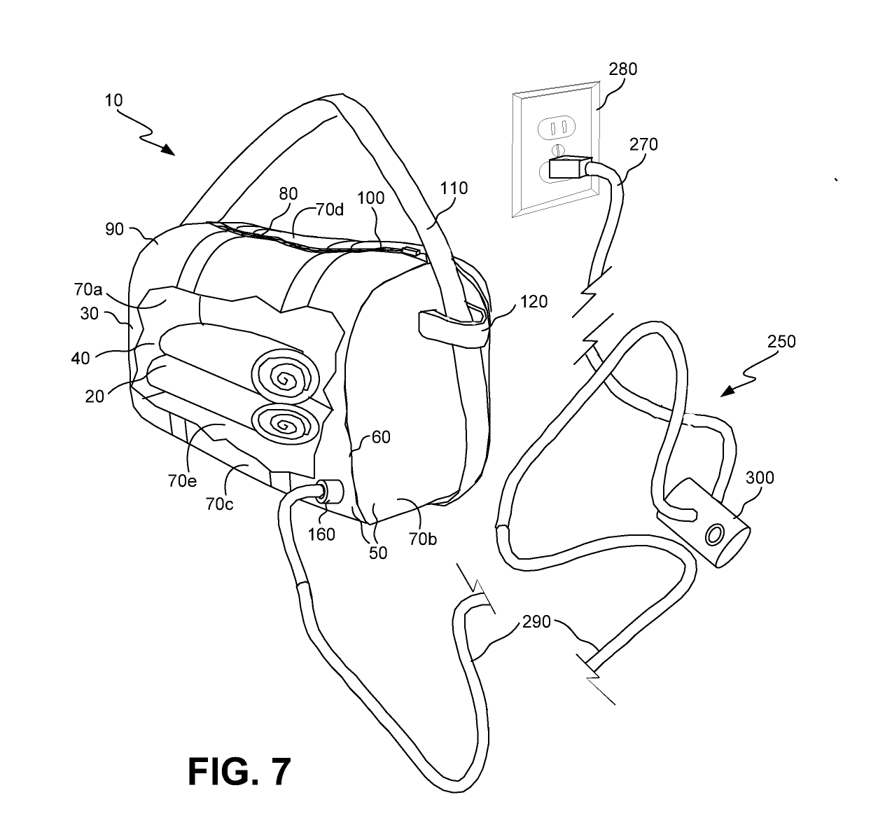

As best seen in FIG. 7, when vacuum source 250 is disposed externally to luggage body 30 so as to provide the external vacuum source, vacuum source 250 may be an external vacuum pump 300 having electrical cord 270 connectable to external power supply 280. External power supply 280 supplies electrical power to external vacuum pump 300 to operate external vacuum pump 300. Vacuum hose 290 interconnects external vacuum pump 300 and second end portion 190 of tubular structure 160. When vacuum hose 290 is connected to second end portion 190 of tubular structure 160, vacuum hose 290 is in communication with air pathway 150. In this manner, operation of external vacuum pump 300 will vacuum air from compartment 40, through air pathway 150, into vacuum hose 290 and to external vacuum pump 300.

Referring to FIGS. 6, 7 and 8, as vacuum source 250 (e.g., vacuum cleaner 260 or external vacuum pump 300) operates, air is evacuated from compartment 40, as previously mentioned. Evacuation of air from compartment 40 creates a vacuum within compartment 40 that forces flexible panels 70a/70b/70c/70d of case body 30 to inwardly collapse or inwardly move until panels 70a/70b/70c/70d compactly and intimately surround items 20 in compartment 40. After sufficient air is evacuated from compartment 40, operation of vacuum source 250 is stopped by the user. If vacuum source 250 is disposed externally to luggage body 30, vacuum hose 290 is then uncoupled from second end portion 190 of tubular structure 160. One-way valve 220 prevents reverse air-flow into now evacuated compartment 40. In this manner, first embodiment vacuum shrinkable luggage 10 shrinks to compactly, compressively enclose items 20 to be carried therein.

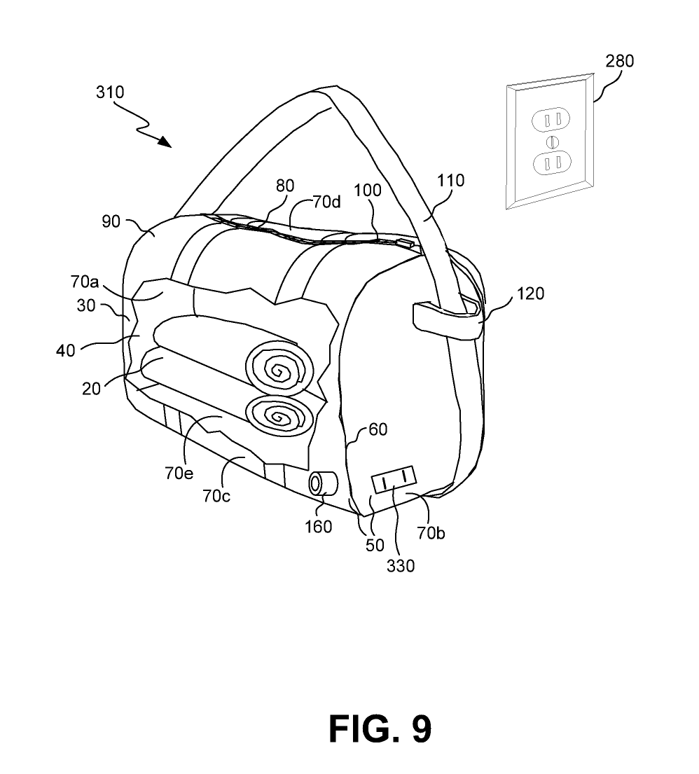

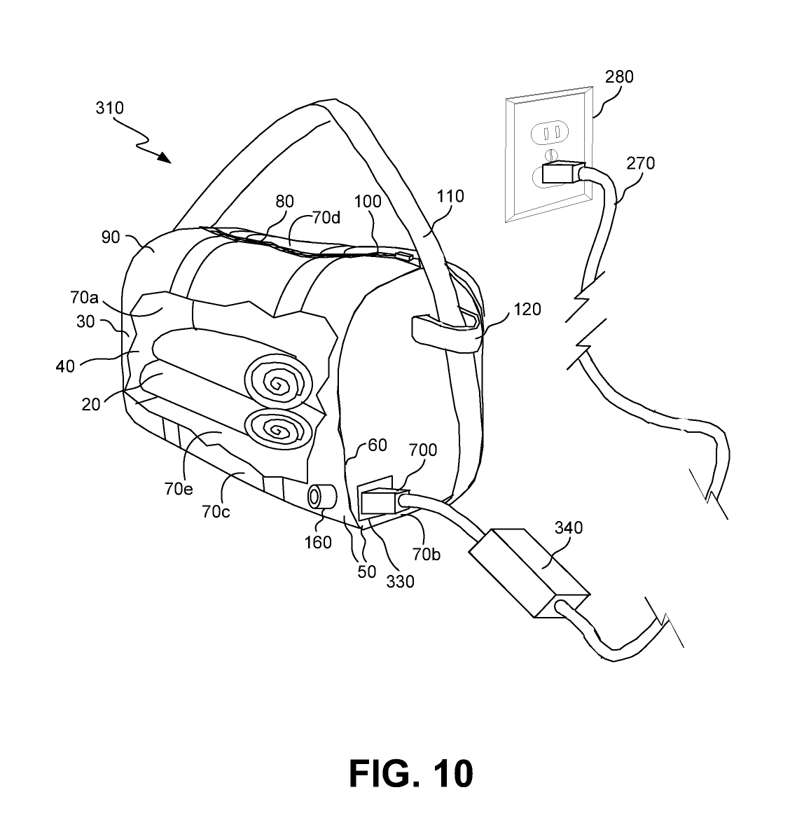

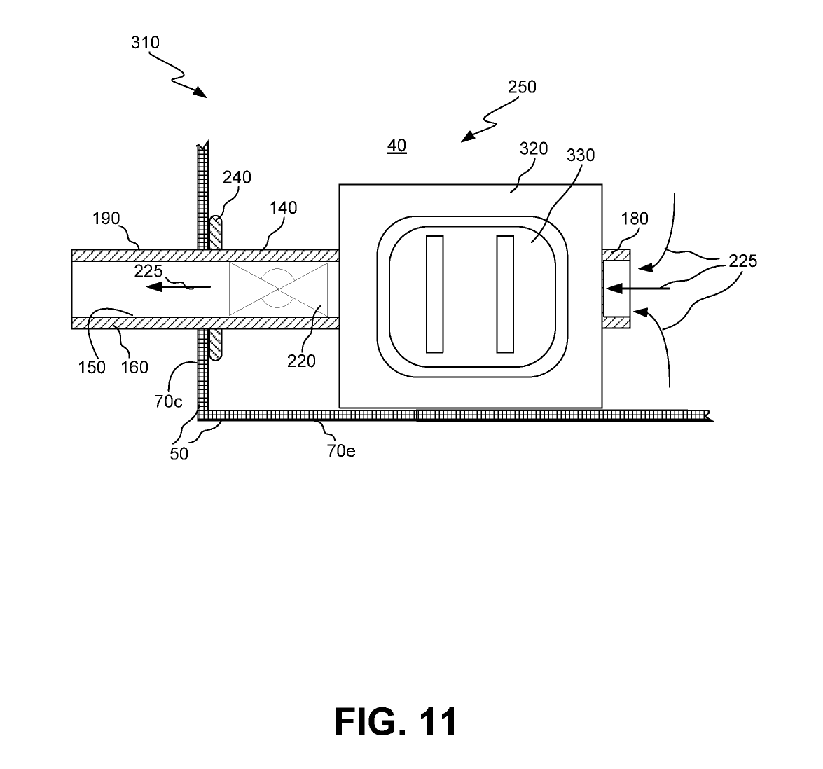

With reference to FIGS. 9, 10 and 11, there is shown a second embodiment vacuum shrinkable luggage, generally referred to as 310, for compactly enclosing item 20 carried therein. Luggage 310 includes collapsible luggage body 30 defining sealable air-tight compartment 40 therein for receiving items 20. According to this second embodiment luggage 310, vacuum source 250 is disposed internally within compartment 40 rather than being disposed externally with respect to compartment 40. More specifically, vacuum source 250 includes an internal vacuum pump 320 that is disposed within compartment 40 and coupled to tubular structure 160, such as being coupled to first end portion 180 of tubular structure 160. Internal vacuum pump 320 includes an electrical connection 330 disposed in any one of panels 50, such as second panel 70b, so as to be available to a suitable electrical adapter 340 disposed externally with respect to luggage body 30. Electrical adapter 340 is adapted to connect electrical connection 330, and therefore internal vacuum pump 320, to power source 280 for providing electrical power to internal vacuum pump 320 to operate internal vacuum pump 320. As internal vacuum pump 320 is electrically operated, air is withdrawn from compartment 40, through air pathway 150 and out tubular structure 160 for producing a vacuum in compartment 40. After sufficient air is withdrawn from compartment 40, electrical adapter 340 is disconnected from electrical connection 330. Thereafter, one-way valve 220 prevents air from reentering compartment 40, so that the vacuum in compartment 40 is maintained.

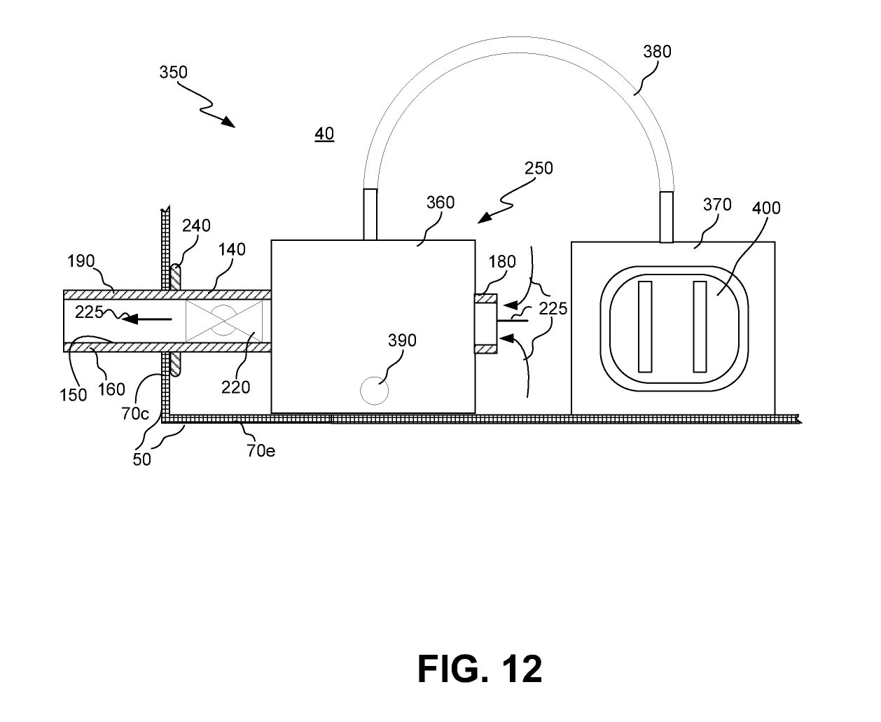

As best seen in FIG. 12, there is shown a third embodiment vacuum shrinkable luggage, generally referred to as 350, for compactly enclosing item 20 carried therein. Luggage 350 includes a third configuration collapsible case body 30 defining sealable air-tight compartment 40 for receiving items 20 therein. According to this third embodiment luggage 350, vacuum source 250 is disposed internally within compartment 40 rather than being disposed externally with respect to compartment 40. More specifically, vacuum source 250 includes an electrically operable internal vacuum pump 360 that is disposed within compartment 40 and coupled to tubular structure 160, such as being coupled to first end portion 180 of tubular structure 160. Internal vacuum pump 360 does not include previously mentioned electrical connection 330. Rather, an internal power supply, such as a rechargeable battery 370, is disposed in compartment 40 and electrically coupled to internal vacuum pump 360. Rechargeable battery 370 is electrically coupled to internal vacuum pump 360 by means of an electrical cable or wire 380 for supplying electrical power to internal vacuum pump 360. Internal vacuum pump 360 is adapted to be turned-on and turned-off by manipulating an on/off toggle switch 390. The on/off toggle switch 390 is disposed in any one of panels 50, such as panel 70b, so as to be available to the user of luggage 350. Also, rechargeable battery 370 includes an electrical connection 400 that is disposed in second panel 70b, so as to be available to previously mentioned electrical adapter 340. Electrical adapter 340 removably connects electrical connection 400, and therefore rechargeable battery 370, to power source 280 for providing electrical power to recharge rechargeable battery 370. After rechargeable battery 370 is sufficiently recharged, electrical adapter 340 is disconnected from electrical connection 400. In addition, after rechargeable battery 370 is sufficiently recharged, internal vacuum pump 360 may be operated by switching-on toggle switch 390. As internal vacuum pump 360 is electrically operated, air is withdrawn from compartment 40, through air pathway 150 and out tubular structure 160 for producing a vacuum in compartment 40. After sufficient air is evacuated from compartment 40 in order to establish the necessary vacuum in compartment 40, internal vacuum pump 360 is caused to cease operation by switching-off toggle switch 390. Thereafter, one-way valve 220 prevents air from reentering compartment 40, so that the vacuum in compartment 40 is maintained until sealable opening 80 is unsealed using zipper 100.

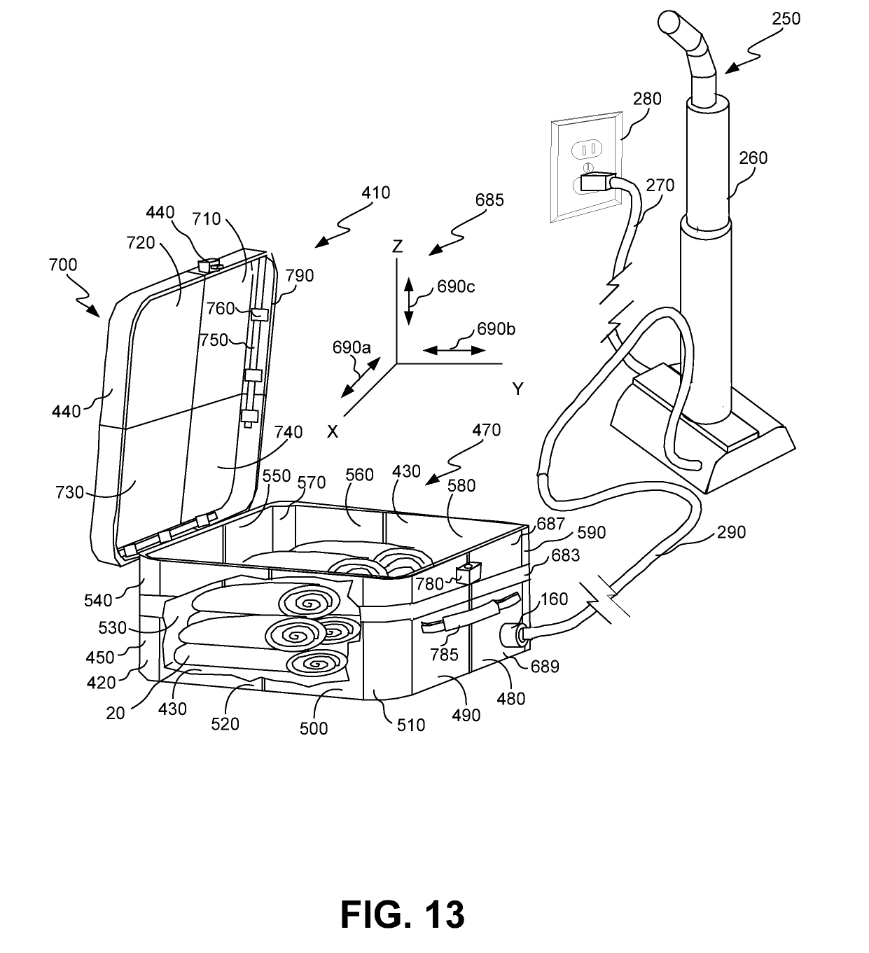

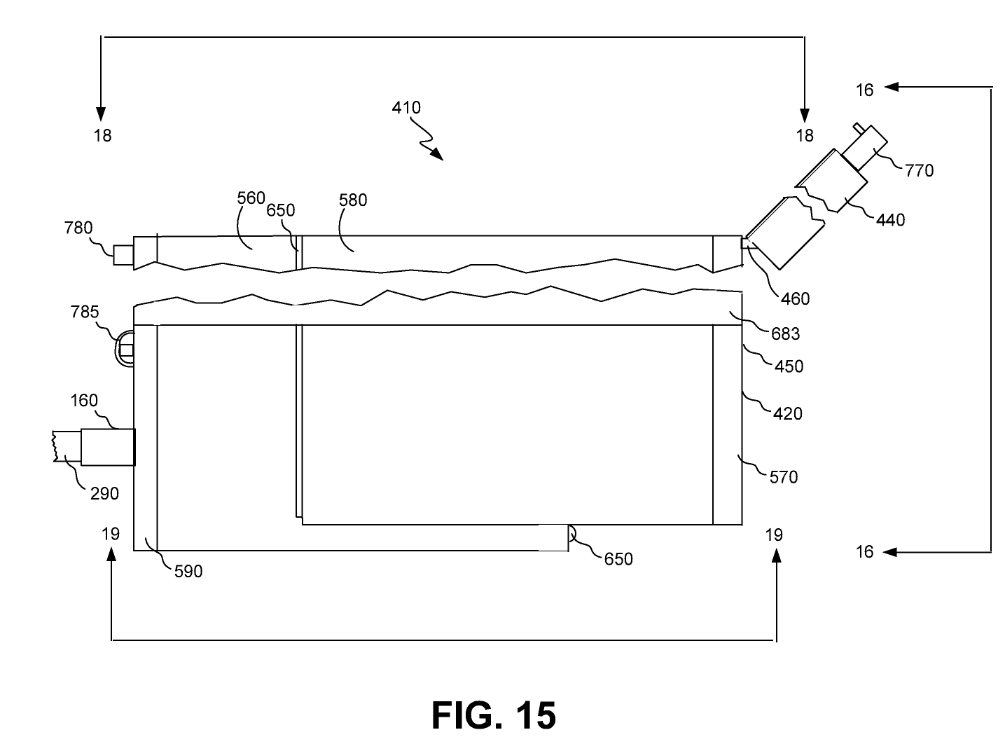

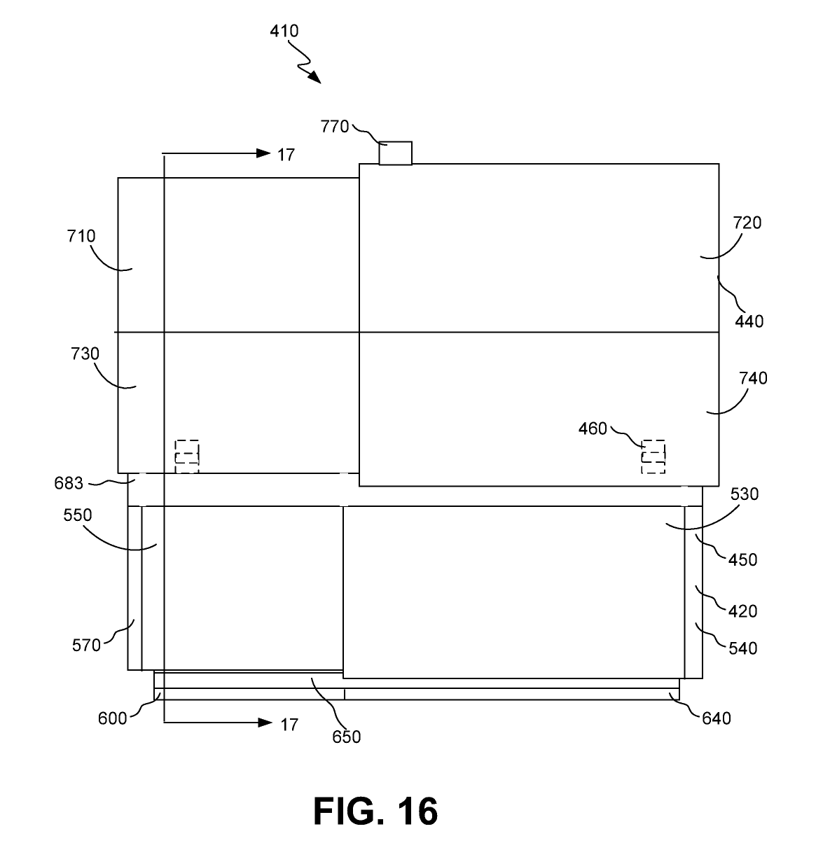

With reference to FIGS. 13, 14, 15 and 16, there is shown a fourth embodiment vacuum shrinkable luggage, generally referred to as 410, for compactly enclosing item 20 carried therein. Luggage 410 includes a collapsible luggage body 420 defining a sealable air-tight compartment 430 therein for receiving items 20. Luggage body 420 may be in the form of a suitcase, as shown. Luggage body 420 includes a sealable cover 440 pivotably attached to a base 450 by means of a plurality of hinges 460. Cover 440 and base 450 include a plurality of adjacent and orthogonal substantially rigid suitcase panels, generally referred to as 470, as described in detail hereinbelow.

Referring again to FIGS. 13, 14, 15 and 16, the structure of base 450 that belongs to luggage body 420 will now be described. In this regard, base 450 includes an upright front first panel 480 slidably engaging an upright front second panel 490. Front first panel 480 slidably engages front second panel 490 in a manner disclosed hereinbelow. Front second panel 490 is sealably coupled to an upright side third panel 500 that is disposed orthogonally with respect to front second panel 490. Front second panel 490 is sealably coupled to side third panel 500 by means of a flexible first upright seal 510, which may be an elastomer. Side third panel 500 slidably engages an upright side fourth panel 520. The side fourth panel 520 is sealably coupled to an upright rear fifth panel 530. Side fourth panel 520 is sealably coupled to rear fifth panel 530 by means of a flexible second upright seal 540, which may be an elastomer. Rear fifth panel 530 slidably engages an upright rear sixth panel 550. The rear sixth panel 550 is sealably coupled to an upright side seventh panel 560. Rear sixth panel 550 is sealably coupled to side seventh panel 560 by means of a third upright seal 570, which may be an elastomer. Seventh side panel 560 slidably engages an upright side eighth panel 580. The side eighth panel 580 is sealably coupled to previously mentioned front first panel 480. Side eighth panel 580 is sealably coupled to first front panel 480 by means of a fourth upright seal 590, which may be an elastomer. Upright seals 510/540/570/590 are made from an elastomeric material, such as rubber, that is capable of elastically expanding while case body 420 is in an uncollapsed state and capable of elastically contracting while case body 420 is in a collapsed state, as described in detail hereinbelow.

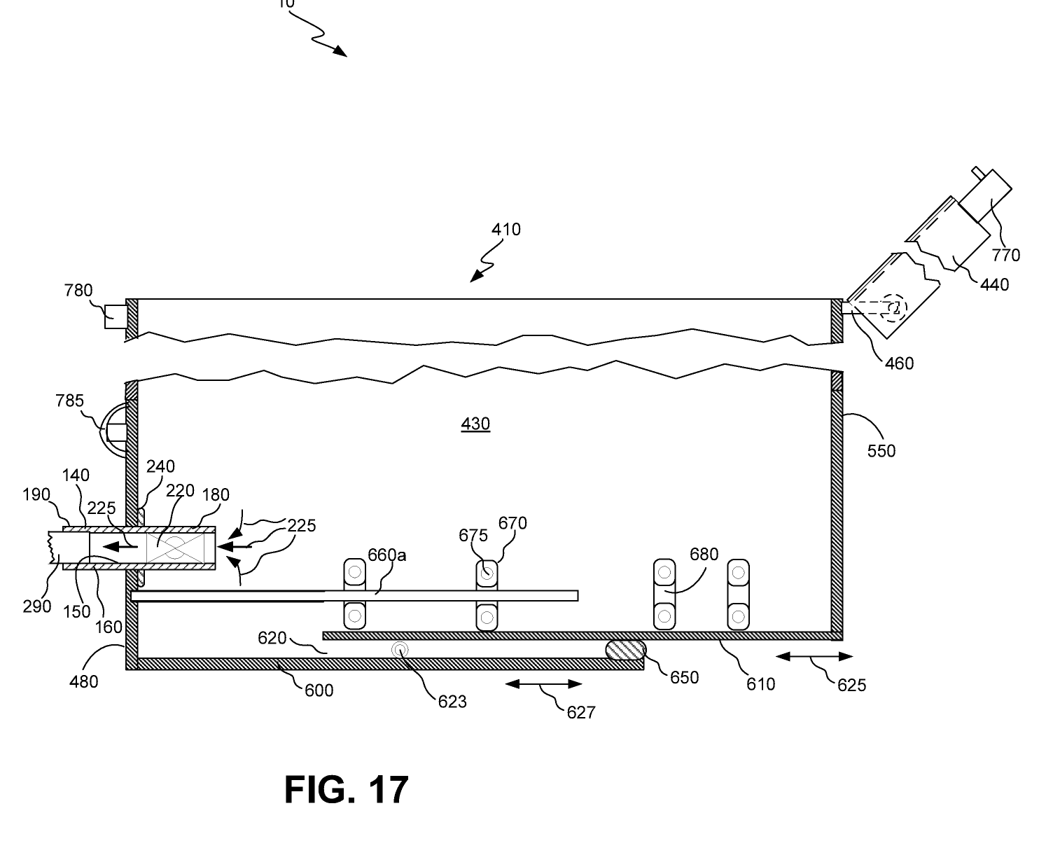

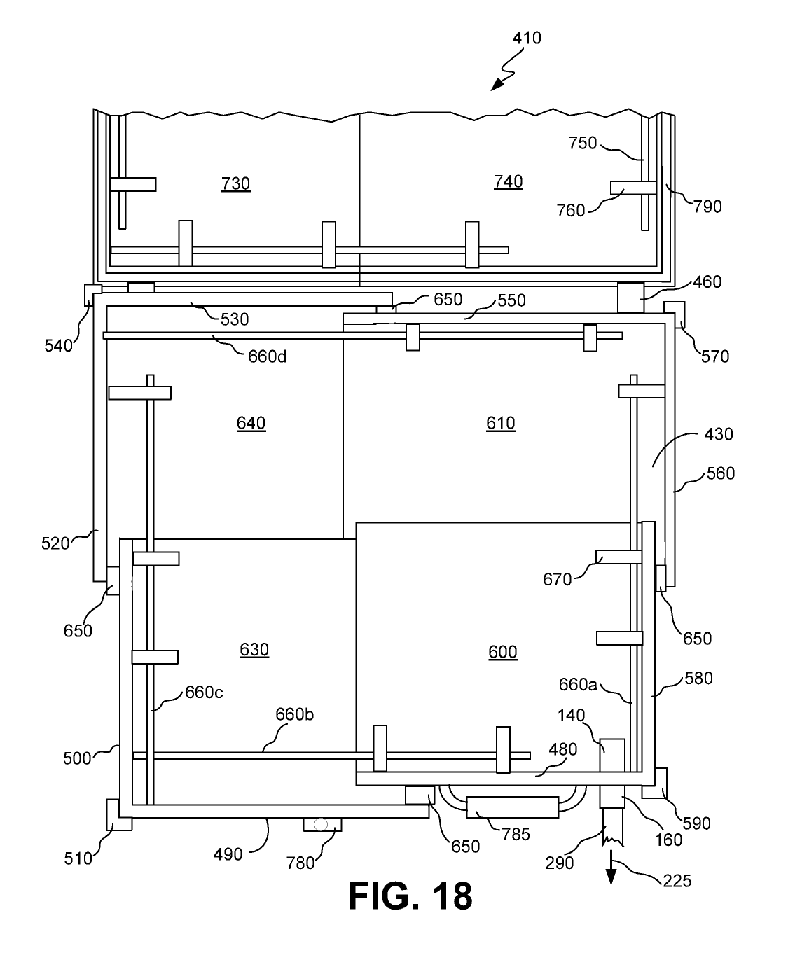

Referring to FIGS. 17 and 18, a horizontal bottom ninth panel 600 is integrally connected to upright front first panel 480 and upright side sixth panel 580. In addition, a horizontal bottom tenth panel 610 is integrally connected to upright rear sixth panel 550 and upright side seventh panel 560. Bottom ninth panel 600 is spaced-apart from bottom tenth panel 610 such that a first groove or gap 620 is defined therebetween. A roller 623 may be disposed in gap 620 so as to be interposed between bottom ninth panel 600 and bottom tenth panel 610 to facilitate horizontal movement or translation of bottom ninth panel 600 relative to bottom tenth panel 610, as indicated by horizontal arrows 625 and 627. It may be appreciated that horizontal movement or translation of bottom ninth panel 600 results in horizontal movement or translation of front first panel 480 and side sixth panel 580 because bottom ninth panel 600 is integrally connected to front first panel 480 and side sixth panel 580. In addition, it may be further appreciated that horizontal movement or translation of bottom tenth panel 610 results in horizontal movement or translation of rear sixth panel 550 and side seventh panel 560 because bottom tenth panel 610 is integrally connected to rear sixth panel 550 and side seventh panel 560.

Referring again to FIGS. 17 and 18, a horizontal bottom eleventh panel 630 is integrally connected to upright front second panel 490 and upright side third panel 500. In addition, a horizontal bottom twelfth panel 640 is integrally connected to upright rear fifth panel 530 and upright side fourth panel 520. Bottom eleventh panel 630 is spaced-apart from bottom twelfth panel 640 such that a second groove or gap (not shown), that is substantially similar to gap 620, is defined therebetween. Previously mentioned roller 623 is disposed in the gap defined between bottom eleventh panel 630 and bottom twelfth panel 640 to facilitate horizontal movement or translation of bottom eleventh panel 630 relative to bottom twelfth panel 640. It may be appreciated that horizontal movement or translation of bottom eleventh panel 630 results in horizontal movement or translation of front second panel 490 and side third panel 500 because bottom eleventh panel 630 is integrally connected to front second panel 490 and side third panel 500. In addition, it may be further appreciated that horizontal movement or translation of bottom twelfth panel 640 results in horizontal movement or translation of rear fifth panel 530 and side fourth panel 520 because bottom twelfth panel 640 is integrally connected to rear fifth panel 530 and side fourth panel 520.

Referring to FIG. 17, an elongate elastomeric gasket seal 650, which may be rubber, is disposed in each gap that is defined by bottom panels 600/610/630/640. In this regard, a plurality of gasket seals 650 are affixed to bottom panels 600/610/630/640 when gasket seals are disposed in respective ones of the gaps. For example, a gasket seal 650 is shown disposed in gap 630 defined between bottom ninth panel 600 and bottom tenth panel 610. A purpose of gasket seals 650 is to seal the gaps, such as gasket seal 650 that seals gap 620, so that air does not enter compartment 430 through the gaps 630 while air is being vacuumed from compartment 430.

Referring to FIGS. 17 and 18, an elongate first guide rail 660a, an elongate second guide rail 660b, an elongate third guide rail 660c and an elongate fourth guide rail 660c are provided to maintain suitcase panels 470 in relative alignment one to another, as described presently. Guide rails 660a/660b/660c/660d are disposed within compartment 430 and spaced above bottom panels 600/5610/630/640. More specifically, first guide rail 660a extends parallel to side seventh panel 560 and side eighth panel 580 and has an end portion thereof affixed to front first panel 480, as shown. Spaced along side seventh panel 560 and side eighth panel 580, and connected thereto, is a plurality of guides 670. Each guide 670 is connected to respective ones of side seventh panel 560 and side eighth panel 580 by a fastener 675, which may be a screw or bolt, or by a suitable adhesive. In addition, each guide 670 defines a bore 680 for slidably receiving respective ones of guide rails 660a/660b/660c/660d therethrough. Thus, it may be appreciated that a purpose of guide rails 660a/660b/660c/660d and guides 670 is to maintain suitcase panels 470 in alignment with each other. In this manner, panels 500/520/530/550/560/580 easily ride or translate along their respective guide rails 660a/660b/660c/660d without misalignment of panels 500/520/530/550/560/580. For example, guide rail 660a and guide 670 cooperate to maintain side seventh panel 560 in alignment with side eighth panel 580 while seventh panel 560 and side eighth panel 580 ride or translate along first guide rail 660a. Moreover, an elastic region 683, which may be made of rubber, extends around the perimeter of base 450 that belongs to case body 420 for reasons disclosed hereinbelow. Elastic region 683 bifurcates each of upright panels 500/520/530/550/560/580 into an upper portion 687 and a lower portion 689 for reasons disclosed hereinbelow.

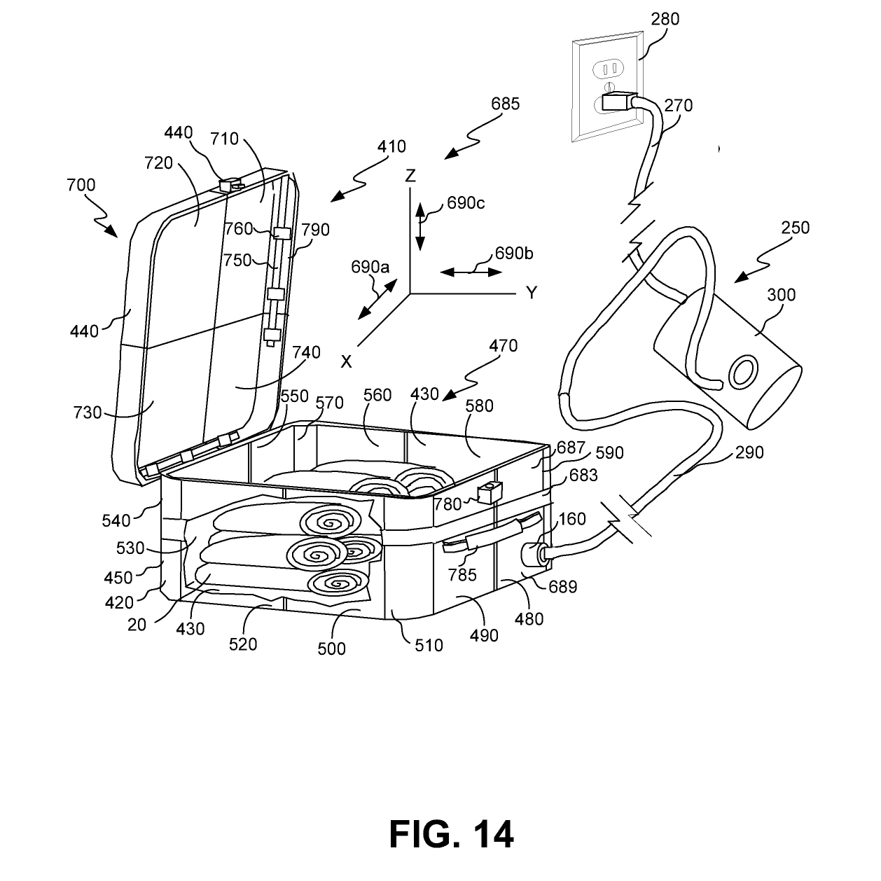

Returning to FIGS. 13 and 14, it may be appreciated by a person of skill in the art of luggage design that movement of panels 500/520/530/550/560/580/600/610/630/640 may be described with regard to a Cartesian coordinate system, generally referred to as 685. In this regard, Cartesian coordinate system 685 has an “X-axis”, a “Y-axis” and a “Z-axis”, as shown. More specifically, with reference to the structure described in detail hereinabove, integrally connected upright front first panel 480, upright side eighth panel 580 and bottom ninth panel 600 will move together in the X-direction and the Y-direction, as indicated by double-headed arrows 690a and 690b, respectively. In addition, integrally connected upright front second panel 490, upright side third panel 500 and bottom eleventh panel 630 will move together in the X-direction and the Y-direction, as indicated by double-headed arrows 690a and 690b, respectively. Further, integrally connected upright side fourth panel 520, upright rear fifth panel 530 and bottom twelfth panel 640 will move together in the X-direction and the Y-direction, as indicated by double-headed arrows 690a and 690b, respectively. Moreover, integrally connected upright rear sixth panel 550, upright side seventh panel 560 and bottom tenth panel 610 will move together in the X-direction and the Y-direction, as indicated by double-headed arrows 690a and 690b, respectively. In this manner, width and depth of base 450 can increase and decrease by the above described movement of panels 500/520/530/550/560/580/600/610/630/640.

Referring again to FIGS. 13 and 14, height of base 450, in addition to width and depth of base 450, can increase and decrease in the Z-direction of Cartesian coordinate system 685. In other words, height of base 450 can increase and decrease in the direction of a double-headed arrow 690c. In this regard, previously mentioned elastic region 683 allows upper portion 687 of base 450 to upwardly and downwardly move. It should be appreciated that upward and downward movement of upper portion 687 allows height of base 450 to respectively increase and decrease.

Still referring to FIGS. 13 and 14, previously mentioned cover 440 includes a plurality of movable cover panels, generally referred to as 700. In this regard, cover panels 700 include a first cover panel 710, a second cover panel 720, a third cover panel 730 and a fourth cover panel 740. Cover 440 also includes a plurality of cover guide rails 750 (only two of which are shown) and associated guides 760 connected to respective ones of first cover panel 710, second cover panel 720, third cover panel 730 and fourth cover panel 740. It may be appreciated by a person of ordinary skill in the art of luggage design that structure of cover panels 710/720/730/740 comprising cover 440 is substantially similar to structure of panels 500/520/530/550/560/580/600/610/630/640 comprising base 450. In this manner, cover panels 710/720/730/740 are adapted to move in the X-direction and the Y-direction, so that cover 440 can shrink or expand the same amount as base 450 after cover 440 closes compartment 430 and covers base 450. Vacuum shrinkable luggage 410 also includes a male latch member 770 connected to cover 440. Male latch member 770 is adapted to engage a female latch member 780 for releasibly locking cover 440 to base 450 after cover 440 closes compartment 430 and covers base 450. Female latch member 780 is connected to base 450. A handle 785 is connected to either or both of front first panel 480 and front second panel 490 for carrying vacuum shrinkable luggage 410. In addition, an annular, elastomeric cover seal 790, which may be rubber, extends around a bottom edge or rim of cover 440 for creating an air-tight seal between cover 440 and base 450 after cover 440 closes compartment 430 and covers base 450. In other words, cover seal 790 maintains cover 440 and base 450 in a seal-tight relationship after cover 440 closes compartment 430 and covers base 450.

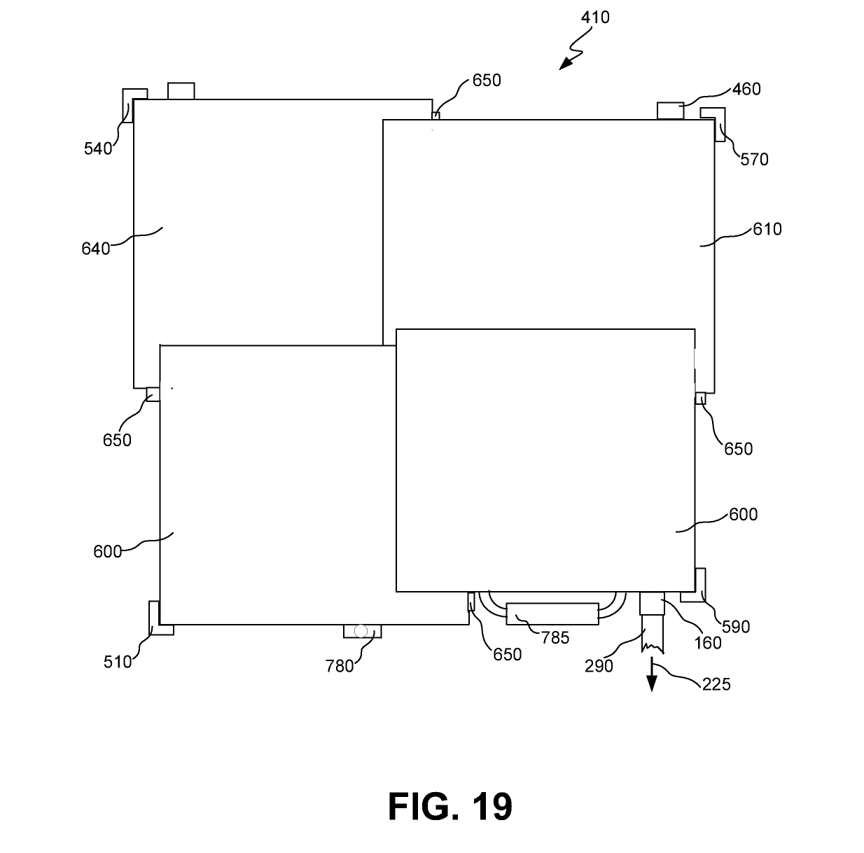

Referring to FIGS. 13, 14, 15, 16, 17, 18 and 19, air is typically present or trapped in compartment 430 after vacuum shrinkable luggage 410 is closed by means of cover 440. It is desirable to remove or evacuate this air from compartment 430 in order to shrink the size of luggage body 420 that belongs to vacuum shrinkable luggage 410. The size of luggage body 420 is determined by height along the Z-axis, width along the X-axis and depth along the Y-axis in Cartesian coordinate system 685. This air is removed by previously mentioned electrically operable vacuum source 250. Vacuum source 250 may be disposed externally to luggage body 420 (i.e., outside compartment 430) so as to provide an external vacuum source or within case body 420 (i.e., within compartment 430) so as to provide an internal vacuum source. When vacuum source 250 is disposed externally to case body 30, vacuum source 250 may be the previously mentioned conventional vacuum cleaner 260 having electrical cord 270 connectable to external power supply 280 to electrically operate vacuum cleaner 260. In this case, vacuum hose 290 interconnects vacuum cleaner 260 and second end portion 190 of tubular structure 160. When vacuum hose 290 is connected to second end portion 190 of tubular structure 160, vacuum hose 290 is in communication with air pathway 150. In this manner, operation of vacuum cleaner 260 will vacuum air from compartment 430, through air pathway 150, into vacuum hose 290 and to vacuum cleaner 260. Alternatively, vacuum source 250 may be the previously mentioned external vacuum pump 300 having electrical cord 270 connectable to external power supply 280 to electrically operate external vacuum pump 300. Vacuum hose 290 interconnects external vacuum pump 300 to second end portion 190 of tubular structure 160. When vacuum hose 290 is connected to second end portion 190 of tubular structure 160, vacuum hose 290 is in communication with air pathway 150. In this manner, operation of external vacuum pump 300 will vacuum air from compartment 430, through air pathway 150, into vacuum hose 290 and to external vacuum pump 300.

Referring again to FIGS. 13, 14, 15, 16, 17, 18 and 19, after cover 440 is closed and as vacuum source 250 (e.g., vacuum cleaner 260 or external vacuum pump 300) operates, air is evacuated from compartment 430, as previously mentioned. Evacuation of air from compartment 430 creates a relatively lower pressure within compartment 430 that forces all panels 500/520/530/550/560/580/600/610/630/640, including elastic region 683, of case body 420 to inwardly move toward the center of luggage body 420 for defining a compressed state of luggage 410. In this manner, panels 500/520/530/550/560/580/600/610/630/640, including elastic region 683, will compactly and intimately surround items 20 in compartment 430. After sufficient air is evacuated from compartment 430, operation of vacuum source 250 is stopped by the user. One-way valve 220 prevents reverse air-flow into now evacuated compartment 430. In this manner, vacuum shrinkable luggage 410 of the invention shrinks to compactly, compressively enclose items 20 to be carried therein.

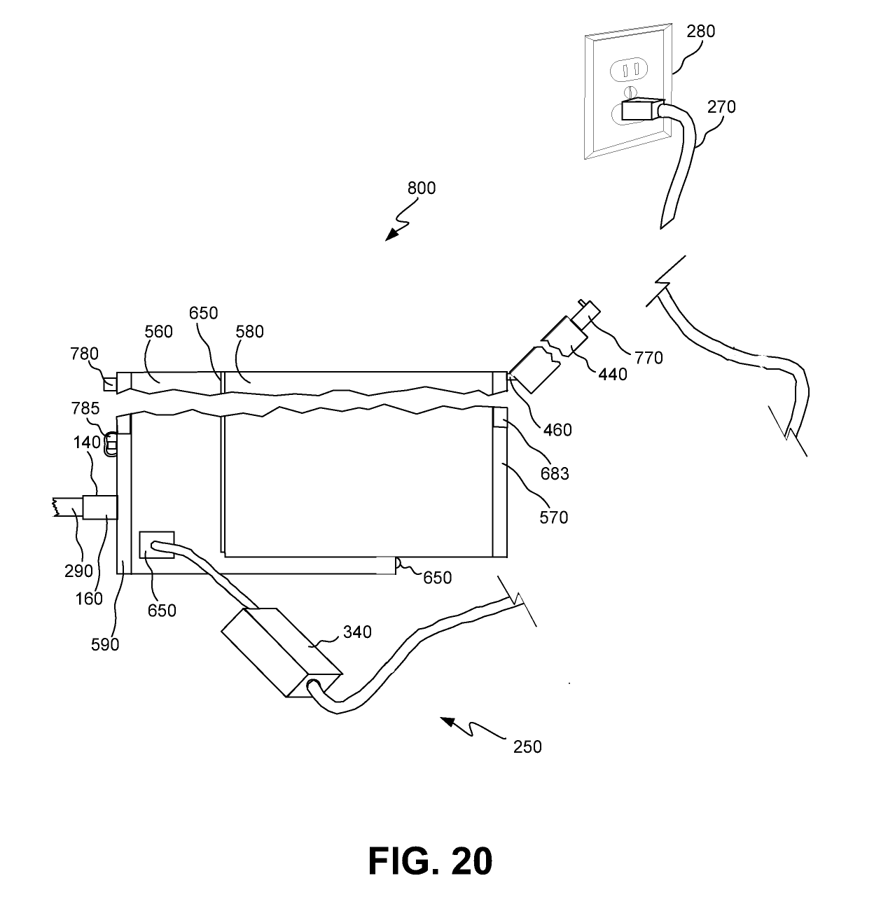

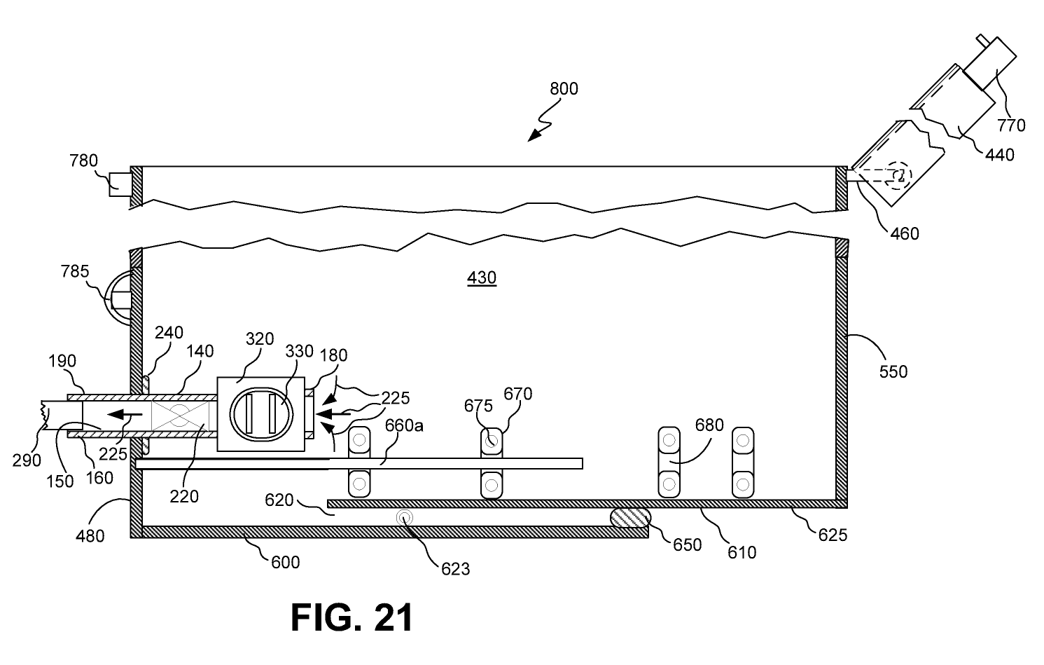

With reference to FIGS. 20 and 21, there is shown a fifth embodiment vacuum shrinkable luggage, generally referred to as 800, for compactly enclosing article 20 carried therein. Luggage 800 includes collapsible luggage body 420 defining sealable air-tight compartment 430 therein for receiving items 20. According to this fifth embodiment luggage 800, vacuum source 250 is disposed internally within compartment 430 rather than being disposed externally with respect to compartment 430. More specifically, vacuum source 250 includes internal vacuum pump 320 that is disposed within compartment 430 and coupled to tubular structure 160, such as being coupled to first end portion 180 of tubular structure 160. Internal vacuum pump 320 includes electrical connection 330 disposed in any one of panels 470, such as side eighth panel 580, so as to be available to electrical adapter 340. Electrical adapter 340 is adapted to connect electrical connection 330, and therefore internal vacuum pump 320, to power source 280 for providing electrical power to internal vacuum pump 320 in order to electrically operate vacuum pump 320. As internal vacuum pump 320 is electrically operated, air is withdrawn from compartment 430, through air pathway 150 and out tubular structure 160 for producing a vacuum in compartment 430. After sufficient air is withdrawn from compartment 430, electrical adapter 340 is disconnected from electrical connection 330. Thereafter, one-way valve 220 prevents air from reentering compartment 40, so that the vacuum in compartment 430 is maintained.

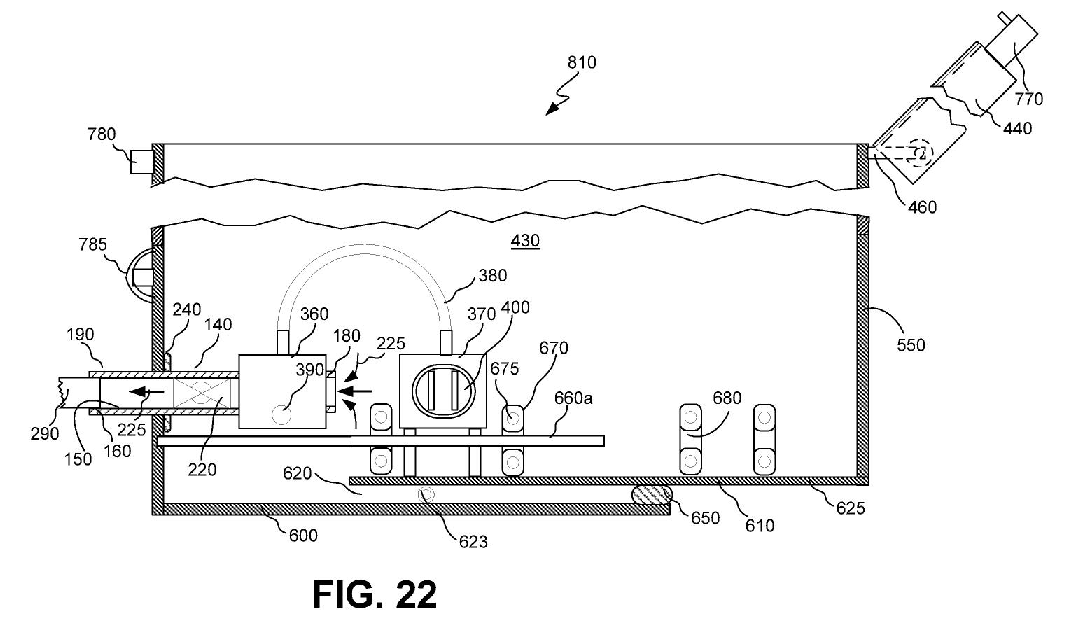

As best seen in FIG. 22, there is shown a sixth embodiment vacuum shrinkable luggage, generally referred to as 810, for compactly enclosing item 20 carried therein. Luggage 810 includes collapsible luggage body 420 defining sealable air-tight compartment 430 therein for receiving items 20. According to this sixth embodiment luggage 810, vacuum source 250 is disposed internally within compartment 430 rather than being disposed externally with respect to compartment 430. More specifically, vacuum source 250 includes electrically operable internal vacuum pump 360 that is disposed within compartment 430 and coupled to tubular structure 160, such as being coupled to first end portion 180 of tubular structure 160. Internal vacuum pump 360 does not include previously mentioned electrical connection 330. Rather, an internal power supply, such as previously mentioned rechargeable battery 370, is disposed in compartment 430 and electrically coupled to internal vacuum pump 360. Rechargeable battery 370 is electrically coupled to internal vacuum pump 360 by means of electrical cable or wire 380 for supplying electrical power to internal vacuum pump 360. Internal vacuum pump 360 can be turned-on and turned-off by manipulating on/off toggle switch 390. The on/off toggle switch 390 is disposed in any one of panels 470, such as side eighth panel 580, so as to be available to the user of luggage 810. Also, rechargeable battery 370 includes electrical connection 400 that is disposed in side eighth panel 580, so as to be available to previously mentioned electrical adapter 340. Electrical adapter 340 removably connects electrical connection 400, and therefore rechargeable battery 370, to power source 280 for providing electrical power to recharge rechargeable battery 370. After rechargeable battery 370 is sufficiently recharged, electrical adapter 340 is disconnected from electrical connection 400. Also, after rechargeable batter 370 is sufficiently recharged, internal vacuum pump 360 may be operated by switching-on toggle switch 390. As internal vacuum pump 360 is electrically operated, air is withdrawn from compartment 40, through air pathway 150 and out tubular structure 160 for producing a vacuum in compartment 40. After sufficient air is evacuated from compartment 40 in order to establish the necessary vacuum in compartment 40, internal vacuum pump 360 is caused to cease operation by switching-off toggle switch 390. Thereafter, one-way valve 220 prevents air from reentering compartment 430, so that the vacuum in compartment 430 is maintained until cover 440 is lifted to unseal compartment 430.

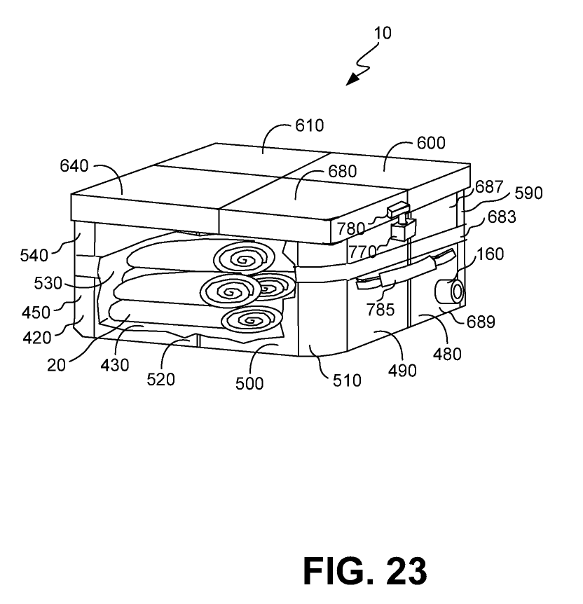

Referring to FIG. 23, there is shown previously mentioned fourth embodiment luggage 410 with cover 440 closed and in an uncompressed state. In this uncompressed state, luggage 410 is illustrated before the vacuum is applied.

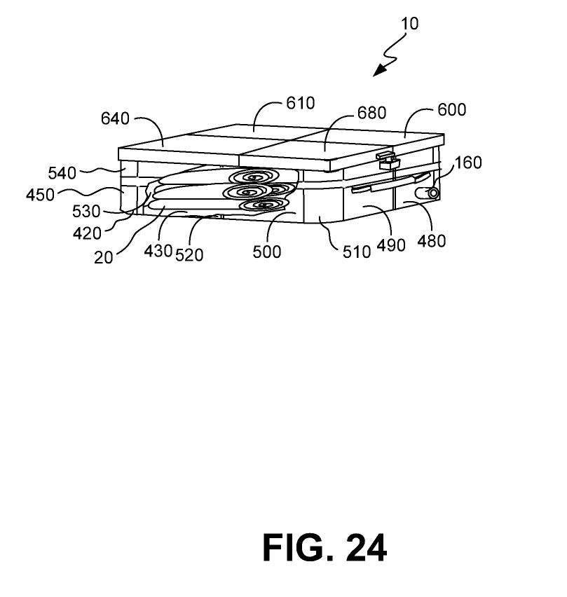

Referring to FIG. 24, there is shown previously mentioned fourth embodiment luggage 410 with cover 440 closed and in a compressed state. In this compressed state, luggage 410 is illustrated after the vacuum is applied.

### Illustrative Methods

An illustrative method associated with exemplary embodiments for assembling a vacuum shrinkable luggage for compactly enclosing an item carried therein will now be described.

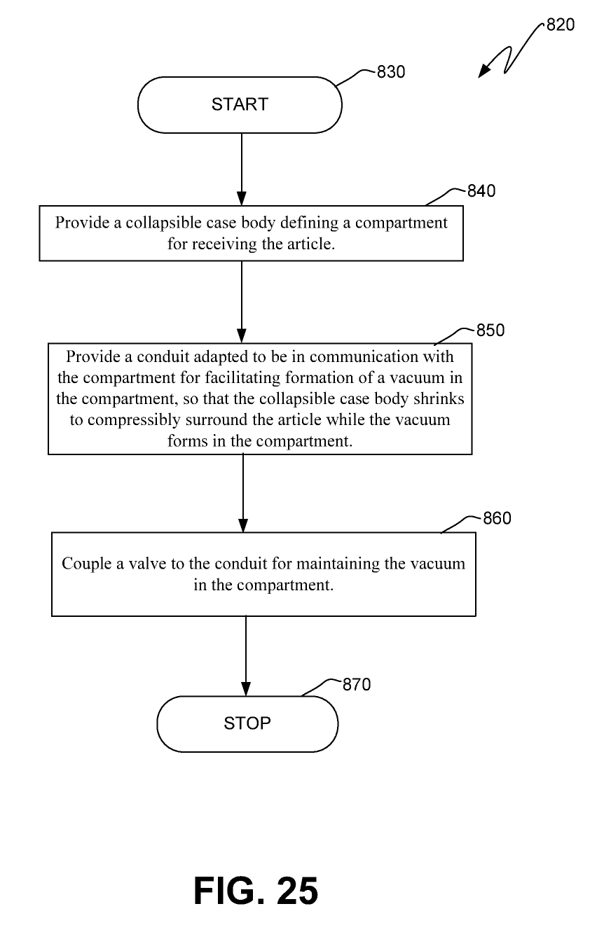

Referring to FIG. 25, an illustrative method 820 that is provided for assembling a vacuum shrinkable luggage for compactly enclosing an item (or “article”) carried therein starts at a block 830. At a block 840, a compressible luggage (or “case”) body defining a compartment for receiving the item is provided. At a block 850, a conduit adapted to be in communication with the compartment is provided for facilitating formation of low pressure (also called “vacuum”) in the compartment, so that the collapsible luggage body shrinks to compressibly surround the item while low pressure forms within the compartment. At a block 860, a valve is coupled to the conduit for maintaining the low air pressure within the compartment. The method stops at a block 870.

Other modifications and implementations will occur to those skilled in the art without departing from the spirit and the scope of the invention as claimed. For example, an air pressure gauge may be in communication with the compartment and disposed in a panel of the luggage, so that measurement of air pressure within the compartment is viewable by the user from outside the luggage. A purpose of the pressure gauge would be to display when a sufficiently low air pressure is reached inside the compartment. As another example, the luggage may be liquid-tight, as well as air-tight, for preventing liquid or moisture (i.e., water) from entering the luggage. This may be particularly useful when electronic devices (e.g., cell phone, laptop computer, etc.) are placed in the luggage. Accordingly, the description hereinabove is not intended to limit the invention, except as indicated in the following claims.

What is claimed is:

1. Vacuum-shrinkable luggage for compressing and carrying at least one item contained therein, the vacuum-shrinkable luggage comprising:
a compressible air-tight luggage body defining a compartment for containing the at least one item, the compressible luggage body enabling the vacuum-shrinkable luggage to shrink in size as air pressure falls within the compressible luggage body;
a conduit, in air communication with the compartment, for enabling air to leave the compartment so as to cause air pressure to fall within the compartment; and
a valve, cooperative with the conduit, to ensure that air leaves, and cannot re-enter, the compartment so as to maintain a low air pressure condition within the compartment while the vacuum-shrinkable luggage is transported.

2. The vacuum-shrinkable luggage of claim 1, further comprising:
a vacuum source coupled to the conduit for causing air to leave the compartment.

3. The vacuum-shrinkable luggage of claim 2, wherein the vacuum source is disposed outside the compartment.

4. The vacuum-shrinkable luggage of claim 2, wherein the vacuum source is disposed inside the compartment.

5. The vacuum-shrinkable luggage of claim 2, further comprising:
a power supply disposed in the compartment and coupled to the vacuum source for supplying power to the vacuum source.

6. The vacuum-shrinkable luggage of claim 1, further comprising:
a seal for sealing the compartment in a substantially air-tight manner.

7. Vacuum-shrinkable luggage for compressing and carrying at least one item contained therein, the vacuum-shrinkable luggage comprising:
a compressible air-tight luggage body having a sealable air-tight compartment for containing the at least one item therein, the compressible luggage body enabling the vacuum-shrinkable luggage to shrink in size as air pressure falls within the compressible luggage body;
a conduit, in air-flow communication with the compartment, for enabling air to leave the compartment so as to cause air pressure to fall within the compartment;
a valve, cooperative with the conduit, capable of ensuring that air can exit, and cannot re-enter, the compartment so as to create and then maintain a low air pressure condition within the compartment while the vacuum-shrinkable luggage is transported; and
an electrically operable vacuum pump in airflow communication with the air pathway for evacuating air out of the compartment via the air pathway.

8. The vacuum-shrinkable luggage of claim 7, wherein the vacuum pump is disposed outside the compartment.

9. The vacuum-shrinkable luggage of claim 7, wherein the vacuum pump is disposed inside the compartment.

10. The vacuum-shrinkable luggage of claim 7, further comprising:
an electrical power supply disposed within the compartment and coupled to the vacuum pump for supplying electrical power to the vacuum pump.

11. The vacuum-shrinkable luggage of claim 10, wherein the electrical power supply is a battery.

12. The vacuum-shrinkable luggage of claim 7, further comprising:
a seal in sealing relationship with the compartment for providing the compartment with an air-tight seal.

13. The vacuum-shrinkable luggage of claim 12, wherein the seal includes a plurality of seal elements adapted to surround the compartment.

14. A method for assembling a vacuum-shrinkable luggage for compressing and carrying at least one item contained therein, the method comprising:
providing a compressible air-tight luggage body defining a compartment for containing the at least one item, the compressible luggage body enabling the vacuum-shrinkable luggage to shrink in size as air pressure falls within the compressible luggage body;
providing a conduit, in air communication with the compartment, for enabling air to leave the compartment so as to cause air pressure to fall within the compartment; and
connecting a valve to the conduit, to ensure that air leaves, and cannot re-enter, the compartment so as to maintain a low air pressure condition within the compartment while the vacuum-shrinkable luggage is transported.

15. The method of claim 14, further including providing a vacuum source adapted to be coupled to the conduit for evacuating air through the conduit.

16. The method of claim 15, wherein providing a vacuum source includes providing a vacuum source adapted to be disposed outside the compartment.

17. The method of claim 15, wherein providing a vacuum source includes providing a vacuum source adapted to be disposed inside the compartment.

18. The method of claim 15, further comprising:
configuring the compartment to receive a power supply adapted to be coupled to the vacuum source for supplying power to the vacuum source.

19. The method of claim 14, further comprising:
disposing a seal in sealing relationship with the compartment for providing the compartment with an air-tight seal.
